(19) United States
(12) Patent Application Publication
(10) Pub. No.: US 2012/0320716 A1
(43) Pub. Date: Dec. 20, 2012

(54) Calendar Views with Color-Coded Event Density

(76) Inventors: Matthew Francis DiMaggio, San Francisco, CA (US); Raymond S. Sepulveda, San Jose, CA (US); Steven P. Jobs, Palo Alto, CA (US); BJ Watrous, Menlo Park, CA (US)

(21) Appl. No.: 13/350,486

(22) Filed: Jan. 13, 2012

Related U.S. Application Data
(60) Provisional application No. 61/433,191, filed on Jan. 14, 2011.

(51) Int. Cl. G04C 17/00

(52) U.S. Cl. 368/29

(57) ABSTRACT

Electronic calendar views are disclosed that include color-coded event density. In some implementations, a number of colors are used to indicate event density in calendar views. Headers of the calendar views can also be color-coded. Color-coding can include coloring day backgrounds or day numbers.

### CROSS-REFERENCE TO RELATED APPLICATIONS

This application claims priority to U.S. Provisional Application No. 61/433,191, filed on Jan. 14, 2011, entitled “Calendar Views with Color-Coded Event Density,” the entire contents of which are incorporated herein by reference.

### TECHNICAL FIELD

This disclosure relates generally to user interfaces for electronic calendars.

### BACKGROUND

An electronic calendar is a time management tool that tracks events and appointments. Multiple calendar views (e.g., home or work calendars) can identify conflicts and free time. Some electronic calendars integrate with network services to allow sharing of calendars with other devices (e.g., personal computers, smart phones) over a network. Some electronic calendars allow notification of upcoming events either on screen, by email, text messaging or pager.

### SUMMARY

Electronic calendar views are disclosed that include color-coded event density. In some implementations, a number of colors are used to indicate event density in calendar views (e.g., mini calendar views). Headers of the calendar views can also be color-coded. Color-coding can include coloring day backgrounds with a number of colors (e.g., five colors) or coloring day numbers. In some implementations, a method includes determining a calendar event density for at least a portion of an electronic calendar, and displaying a calendar view of the electronic calendar including a color-coding indicating a density of calendar events.

Particular implementations disclosed herein can be implemented to realize one or more of the following advantages. Calendar views with color-coded density provide a time management tool that allows users to assess free time available in a month or year with a single intuitive calendar view.

The details of one or more implementations are set forth in the accompanying drawings and the description below. Other features, aspects, and advantages will become apparent from the description, the drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1-5 are exemplary calendar views illustrating color-coded event density.

FIG. 6 is a flow diagram of an exemplary process for generating a calendar view with color-coded event density.

FIG. 7 is exemplary system architecture for implementing the features and processes described in reference to FIGS. 1-6.

Like reference symbols in the various drawings indicate like elements.

### DETAILED DESCRIPTION

### Exemplary Calendar Views with Color-Coded Density

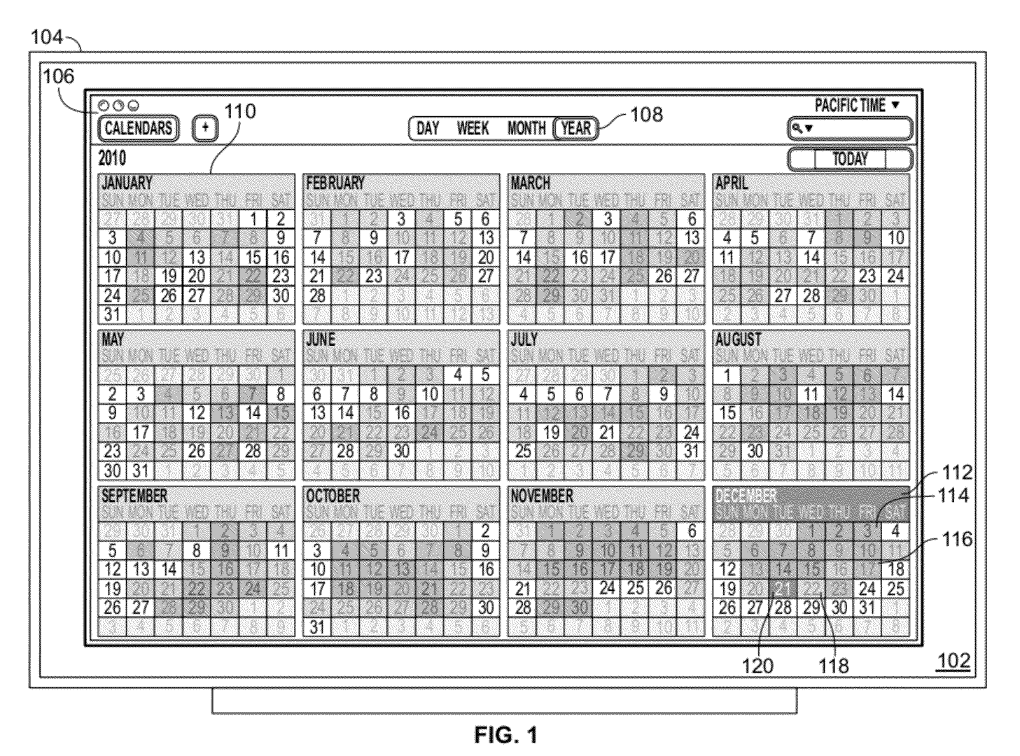

FIG. 1 is a first calendar view 106 with color-coded event density. In some implementations, an electronic calendar application running on device 104 generates and displays calendar view 106 on display 102 of electronic device 104. Electronic device 104 can be an electronic device capable of generating and displaying a calendar view with color-coded event density, including but not limited to: a personal computer, a handheld computer, a personal digital assistant (PDA), a cellular telephone, an electronic tablet, a camera, a smart phone, a media player, a navigation device, an email device, a game console, a television system, a media center system or a combination of any two or more of these electronic devices or other electronic devices.

Display 102 can be any display capable of displaying a calendar view with color-coded event density, including but not limited to: a computer monitor (e.g., liquid crystal display (LCD), light emitting diode (LED) display), a television screen, a touch sensitive screen or a combination of any two or more of these displays or other displays.

In some implementations, calendar view 106 can be presented in one or more display formats, including but not limited to: Day, Week, Month and Year display formats. In the example shown, Year format 108 is selected. Year format 108 can include mini calendar views 110 for each month of the calendar year. Each mini calendar view 110 can include a month header 112 and days with color-coded backgrounds (the square or rectangular background behind the day number in the calendar) for each day of the month. The color of the background indicates an event density for the day or the number of events (e.g., personal or business meetings, public or private events) that have been added to the electronic calendar for that day. Any number of colors can be used to indicate event density for the day (e.g., 3 or 5 colors). In the example shown, five colors are used. A white colored day indicates no events for that day. A red colored day 114 indicates a high event density for that day. An orange colored day 116 indicates an event density that is less than the red colored day 114. A yellow colored day 118 indicates an event density that is less than the orange colored day 116. Various shades of red, orange and yellow can be used to indicate less or more event density. A blue colored day 120 indicates the current day. Month header 112 can also be colored blue to indicate the current month. Other color variations can be used as desired.

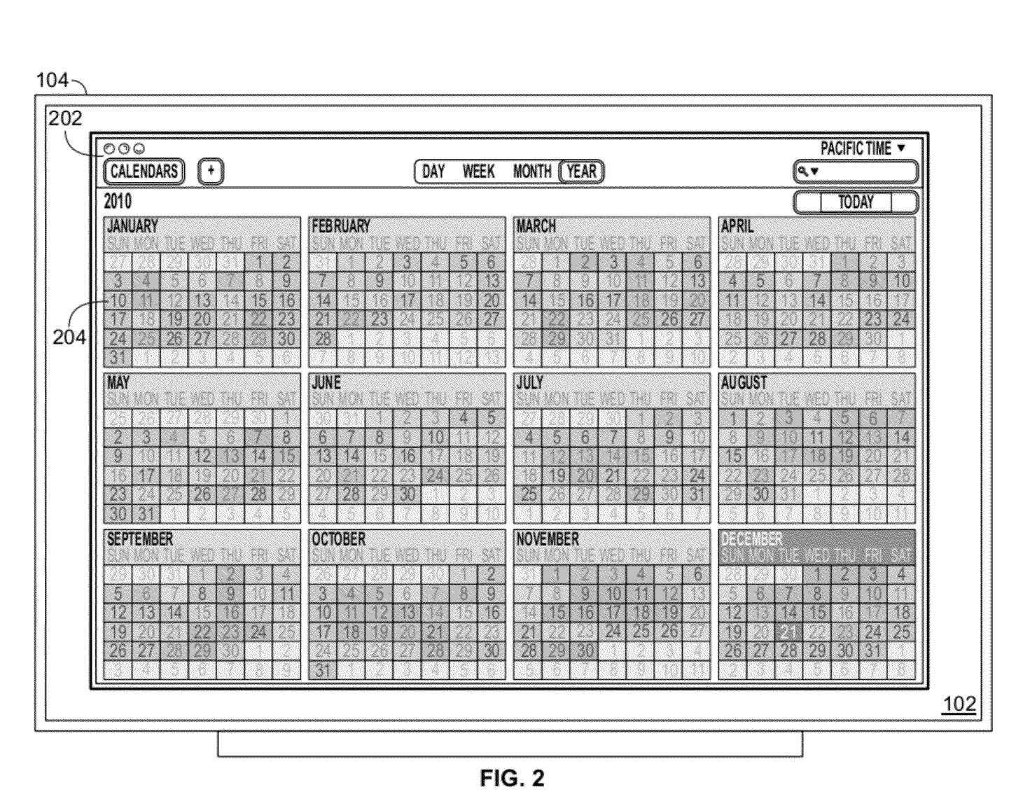

FIG. 2 is a calendar view 202 with a color code to indicate days that are free (e.g., no scheduled events). In the example shown, the color green can be used to indicate a day 204 for which no events are scheduled. Other colors can also be used to show free days.

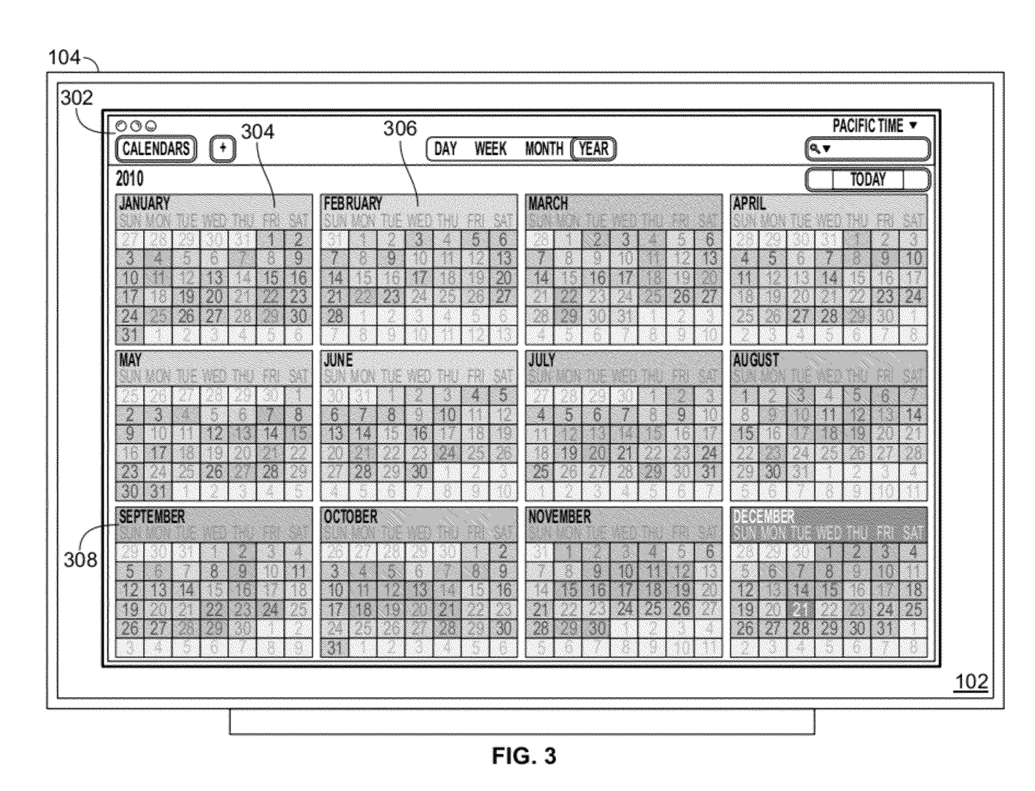

FIG. 3 is a calendar view 302 with color-coded headings for mini calendars. In the example shown, month header 304 for the January mini calendar is colored orange to indicate medium event density for the month of January, month header 306 for the February mini calendar is colored yellow to indicate light event density for the month of February and month header 308 for the September mini calendar is colored red to indicate high event density for the month of September. Other color variations are also possible.

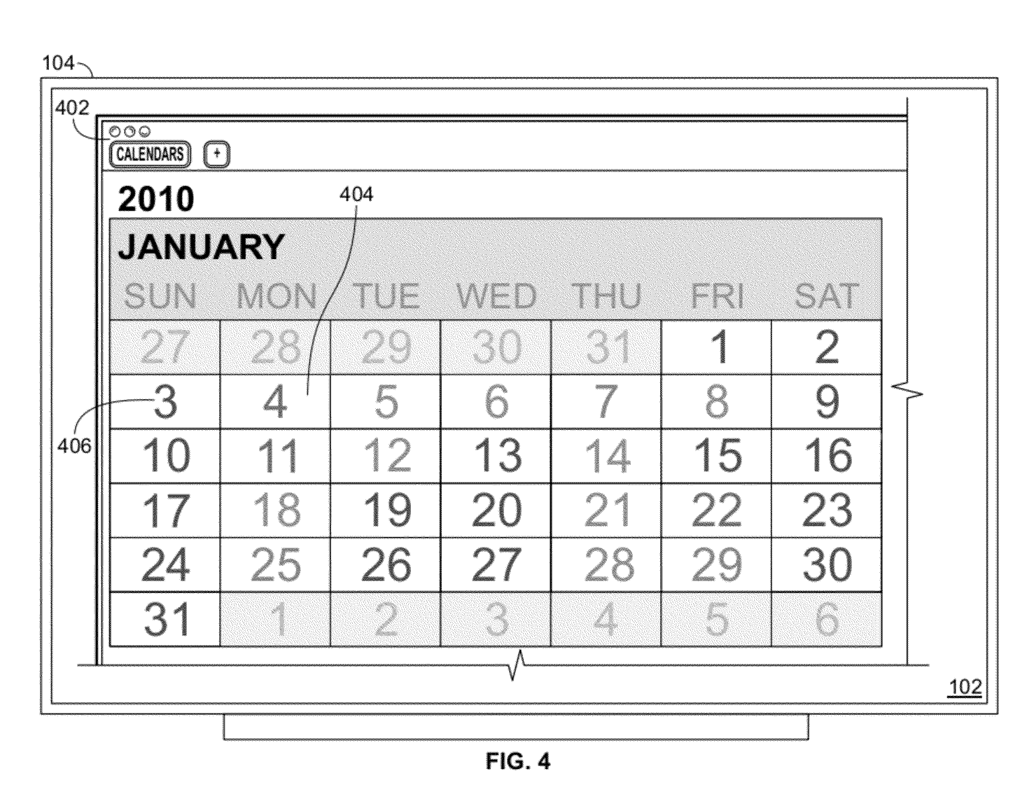

FIG. 4 is a blown-up portion of calendar view 402 with color-coded event density. In the example shown, the day numbers for January are colored rather than the day backgrounds. For example, the day number 406 for day 3 of January is green indicating a free day and the day number 404 for day 4 of January is colored red to indicate a high event density.

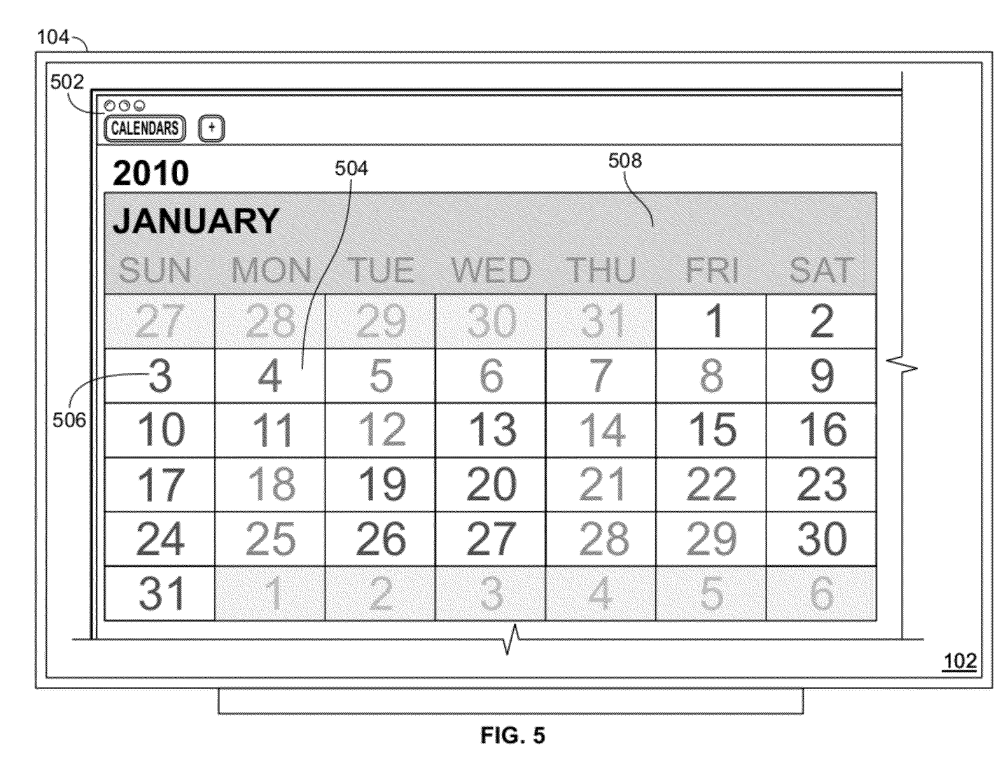

FIG. 5 is a blown-up portion of calendar view 502 with color-coded event density. In the example shown, the day numbers (e.g., day numbers 504, 506) for January are colored to indicate event density for the days in January. Month header 508 is also colored to indicate the event density for the month of January.

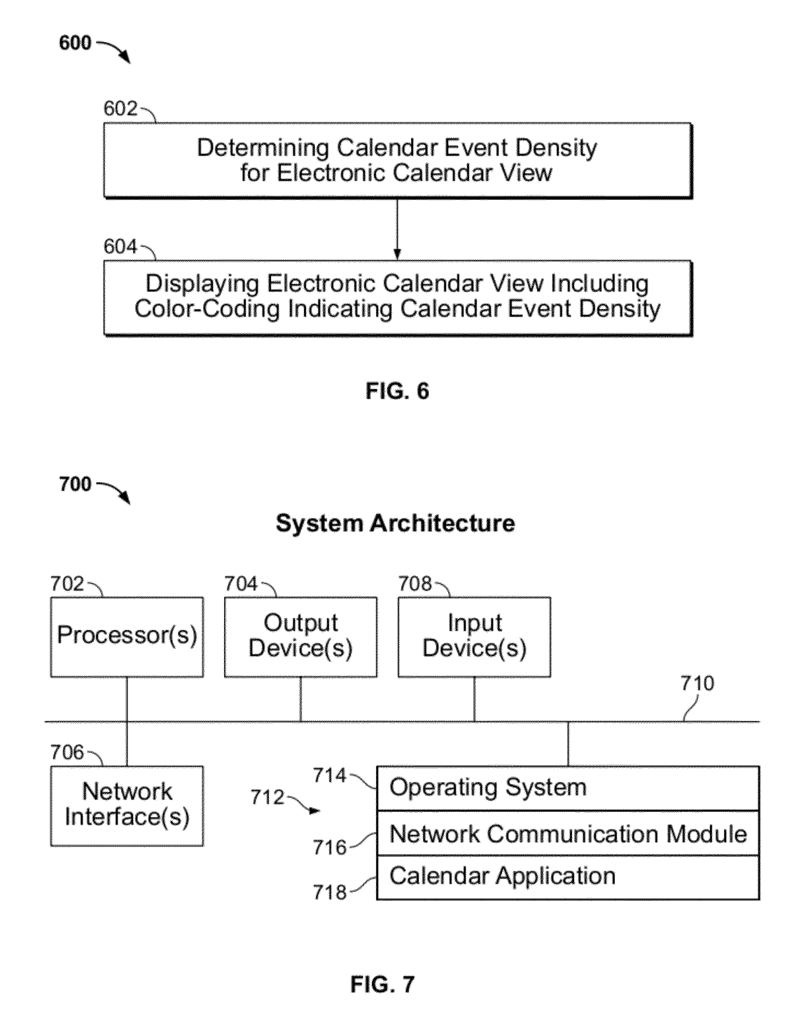

FIG. 6 is a flow diagram of an exemplary process 600 for generating a calendar view with color-coded event density. In some implementations, process 600 can begin by determining calendar event density for an electronic calendar view (602). For example, a number of events in a day can be calculated to determine event density for the day (hereinafter “event count”). In some implementations, the event density can be calculated using a histogram having bins with widths that are based on the event counts for all the days in a calendar year. For example, if three colors are used to show event density in a calendar view, then the event counts can be grouped into three histogram bins. Generally, the width h of the histogram bins can be given by

$$h = ⌈ \frac{max\_cnt - min\_cnt}{k} ⌉ , \qquad [ 1 ]$$

where max_cnt is the maximum event count for a day in the calendar year, min_cnt is the minimum event count for a day in the calendar year, k is the number of colors used for color-coding and the brackets are ceiling brackets. For example, if the maximum number of events is 20, the minimum number of events is 5 and the number of colors is 3, the histogram bin width is 5 based on equation [1]. Thus, the histogram will include 3 bins with event count ranges as indicated in Table I below:

TABLE I
Example Histogram

| Bin | Event Count Range | Color Assigned |
|---|---|---|
| N/A | 0 | White/Green |
| 1 | 5-9 | Yellow |
| 2 | 10-14 | Orange |
| 3 | 15-20 | Red |

After the bin widths are set up, the event count for each day can be sorted in the appropriate bin based on the bin widths and colors can be assigned to the days based on which bin the day falls into. Referring to Table I, the days that have 0 events scheduled can be coded white or green to indicate event density. Days that have 5-9 events scheduled can be coded yellow to indicate a light event density. Days that have 10-14 events scheduled can be coded orange to indicate a medium event density. Days that have 15-20 events scheduled can be coded red to indicate a heavy event density. Other known functions can be used to determine the widths of histogram bins. The total event counts for a month can be used with Table I to assign a color to the header for the month as shown in FIG. 3.

In some implementations, the free time available in a day can be used to determine event density. For example, the durations of each event in a time span can be summed and then subtracted from the total number hours available in that time span (e.g., a 24 hour period). Such an implementation can provide better accuracy for days where many events of short duration are scheduled, such as 8 half hour appointments in the morning and no events scheduled in the afternoon.

Process 600 can continue by displaying the calendar view including color-coding to indicate event density (604). For example, calendar views can include color-coding as described in reference to FIGS. 1-5. In some implementations, when the user “hovers” over a day in a calendar view with a mouse cursor, a preview of the events for that day are displayed (e.g., displayed in a pop-up window).

### Exemplary Device for Displaying Calendar Views

FIG. 7 is exemplary system architecture for implementing the features and processes described in reference to FIGS. 1-6. Other architectures are possible, including architectures with more or fewer components. In some implementations, architecture 700 includes one or more processors 702 (e.g., dual-core Intel® Xeon® Processors), one or more output devices 704 (e.g., LCD), one or more network interfaces 706, one or more input devices 708 (e.g., mouse, keyboard, touch-sensitive display or surface) and one or more computer-readable mediums 712 (e.g., RAM, ROM, SDRAM, hard disk, optical disk, flash memory, etc.). These components can exchange communications and data over one or more communication channels 710 (e.g., buses), which can utilize various hardware and software for facilitating the transfer of data and control signals between components.

The term “computer-readable medium” refers to any medium that participates in providing instructions to processor 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 712 can further include operating system 714 (e.g., Mac OS® server, Windows® NT server), network communication module 716 and calendar application 718. Operating system 714 can be multi-user, multiprocessing, multitasking, multithreading, real time, etc. Operating system 714 performs basic tasks, including but not limited to: recognizing input from and providing output to devices 706, 708; keeping track and managing files and directories on computer-readable mediums 712 (e.g., memory or a storage device); controlling peripheral devices; and managing traffic on the one or more communication channels 710. Network communications module 716 includes various components for establishing and maintaining network connections (e.g., software for implementing communication protocols, such as TCP/IP, HTTP, etc.). Calendar application 718 can be an electronic calendar application that presents the calendar views described in reference to FIGS. 1-6.

Architecture 700 can be included in any device capable of presenting calendar views with color-coded event density. Architecture 700 can be implemented in a parallel processing or peer-to-peer infrastructure or on a single device with one or more processors. Software can include multiple software components or can be a single body of code.

The features described can be implemented in digital electronic circuitry, or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. Alternatively or in addition, the program instructions can be encoded on a propagated signal that is an artificially generated signal, e.g., a machine-generated electrical, optical, or electromagnetic signal that is generated to encode information for transmission to suitable receiver apparatus for execution by a programmable processor.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of exemplary semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include, for example, a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. In addition, other steps may be provided, or steps may be eliminated, from the described flows, and other components may be added to, or removed from, the described systems. Accordingly, other implementations are within the scope of the following claims.

What is claimed is:

1. A method comprising:
determining a calendar event density for at least a portion of an electronic calendar; and
displaying a calendar view of the electronic calendar including color-coding to indicate a density of calendar events,
where the method is performed by one or more processors of a computing device.

2. The method claim 1, where determining calendar event density further comprises:
determining an event count for each day in a calendar year; and
assigning a color to the day based on the event count.

3. The method of claim 2, where assigning a color to the day based on the event count further comprises:
generating a histogram having a number of bins, where each bin is assigned a color;
assigning a day to a bin based on the event count; and
assigning a color to the day based on the bin.

4. The method of claim 3, where generating a histogram having a number of bins further comprises:
generating a histogram having a number of bins, where each bin has a width that is determined based on a maximum event count, a minimum event count and a number of colors used for color-coding.

5. The method of claim 1, where determining calendar event density further comprises:
determining an amount of free time for a day in a calendar year; and
assigning a color to the day based on the amount of free time.

6. The method of claim 1, where displaying a calendar view of the electronic calendar including color-coding to indicate a density of calendar events further comprises:
displaying a calendar view in a year format including mini calendars for each month of a calendar year; and
coloring headings of one or more of the mini calendars according to the determined calendar event density.

7. The method of claim 1, where displaying a calendar view of the electronic calendar including color-coding to indicate a density of calendar events further comprises:
displaying a calendar view in a year format including mini calendars for each month of a calendar year; and
coloring backgrounds of one or more days of the mini calendars according to the determined calendar event density.

8. The method of claim 1, where displaying a calendar view of the electronic calendar including color-coding to indicate a density of calendar events further comprises:
displaying a calendar view in a year format including mini calendars for each month of a calendar year; and
coloring day numbers disposed on backgrounds of one or more days of the mini calendars according to the determined calendar event density.

9. The method of claim 1, where displaying a calendar view of the electronic calendar including color-coding to indicate a density of calendar events further comprises:
displaying a calendar view in a year format including mini calendars for each month of a calendar year;
coloring month headings of one or more days of the mini calendars according to the determined calendar event density; and
coloring day numbers disposed on backgrounds of one or more days of the mini calendars according to the determined calendar event density.

10. A system comprising:
one or more processors;
memory storing instructions, which, when executed by the one or more processors, cause the one or more processors to perform operations comprising:
determining a calendar event density for at least a portion of an electronic calendar; and
displaying a calendar view of the electronic calendar including color-coding to indicate a density of calendar events.

11. The system of claim 10, where determining calendar event density further comprises:
determining an event count for each day in a calendar year; and
assigning a color to the day based on the event count.

12. The system of claim 11, where assigning a color to the day based on the event count further comprises:
generating a histogram having a number of bins, where each bin is assigned a color;
assigning a day to a bin based on the event count; and
assigning a color to the day based on the bin.

13. The system claim 12, where generating a histogram having a number of bins further comprises:
generating a histogram having a number of bins, where each bin has a width that is determined based on a maximum event count, a minimum event count and a number of colors used for color-coding.

14. The system claim 10, where determining calendar event density further comprises:
determining an amount of free time for a day in a calendar year; and
assigning a color to the day based on the amount of free time.

15. The system of claim 10, where displaying a calendar view of the electronic calendar including color-coding to indicate a density of calendar events further comprises:
displaying a calendar view in a year format including mini calendars for each month of a calendar year; and
coloring headings of one or more of the mini calendars according to the determined calendar event density.

16. The system of claim 10, where displaying a calendar view of the electronic calendar including color-coding to indicate a density of calendar events further comprises:
displaying a calendar view in a year format including mini calendars for each month of a calendar year; and
coloring backgrounds of one or more days of the mini calendars according to the determined calendar event density.

17. The system of claim 10, where displaying a calendar view of the electronic calendar including color-coding to indicate a density of calendar events further comprises:
displaying a calendar view in a year format including mini calendars for each month of a calendar year; and
coloring day numbers disposed on backgrounds of one or more days of the mini calendars according to the determined calendar event density.

18. The system claim 10, where displaying a calendar view of the electronic calendar including color-coding to indicate a density of calendar events further comprises:
displaying a calendar view in a year format including mini calendars for each month of a calendar year;
coloring month headings of one or more days of the mini calendars according to the determined calendar event density; and
coloring day numbers disposed on backgrounds of one or more days of the mini calendars according to the determined calendar event density.
